(19) United States
(12) Patent Application Publication
(10) Pub. No.: US 2008/0058438 A1
(43) Pub. Date: Mar. 6, 2008

(54) Reworkable Adhesive

(76) Inventor: Joseph Kuczynski, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/470,512

(22) Filed: Sep. 6, 2006

(51) Int. Cl. H05B 6/68

(52) U.S. Cl. 522/1

(57) ABSTRACT

A method of making a reworkable adhesive including reacting a precursor to a thermally-labile group and a precursor to a UV curable cross-linking monomer; combining the product of the reaction of the precursor to a thermally-labile group and the precursor to a UV curable cross-linking monomer with a photoinitiator, and a filler; and UV curing the combination of the product of the reaction of the precursor to a thermally-labile group and the precursor to a UV curable cross-linking monomer, the photoinitiator and the filler.

### BACKGROUND OF THE INVENTION

1. Field of the Invention

The field of the invention is reworkable adhesives.

2. Description of Related Art

Conventional UV curable acrylate-based adhesives are routinely employed to provide a rigid, hermetic seal for numerous electronic components. Unfortunately, acrylates cross-link to form intractable networks that cannot be reworked. Consequently, the substrate or device to which the adhesive is applied must be discarded if a faulty component is discovered during burn-in or some other downstream process. For example, consider the situation where an optical device is aligned to a housing containing a fiber optic cable. If the housing or lens is damaged in a downstream process, it would be desirable to remove the optical device without destroying the assembly. However, since conventional acrylate-based adhesives cannot be reworked, the device cannot be removed and the assembly must be discarded. There is therefore an ongoing need in the field for reworkable adhesives.

### SUMMARY OF THE INVENTION

A method of making a reworkable adhesive including reacting a precursor to a thermally-labile group and a precursor to a UV curable cross-linking monomer; combining the product of the reaction of the precursor to a thermally-labile group and the precursor to a UV curable cross-linking monomer with a photoinitiator, and a filler; and UV curing the combination of the product of the reaction of the precursor to a thermally-labile group and the precursor to a UV curable cross-linking monomer, the photoinitiator and the filler.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth flow chart illustrating an exemplary method of making a reworkable adhesive according to the present invention.

FIG. 2 sets forth an exemplary reaction in accordance with the present invention.

FIG. 3 depicts a generalized formula of thermally-labile product useful in making reworkable adhesives according to embodiments of the present invention.

FIG. 4 sets forth another reaction useful in making reworkable adhesives in accordance with the present invention.

FIG. 5 sets forth another reaction useful in making reworkable adhesives in accordance with the present invention.

FIG. 6 sets forth a flow chart illustrating a method of reworking an adhesive substance in accordance with the present invention.

### DETAILED DESCRIPTION OF EXEMPLARY EMBODIMENTS

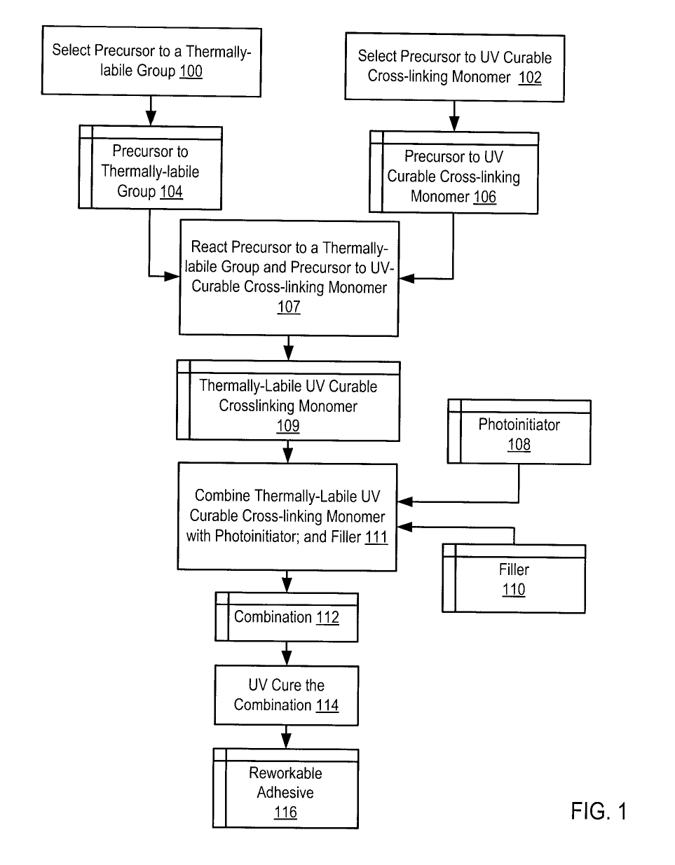

Exemplary methods and adhesives in accordance with the present invention are described with reference to the accompanying drawings, beginning with FIG. 1. FIG. 1 sets forth a flow chart illustrating an exemplary method of making a reworkable adhesive according to the present invention. The method of FIG. 1 includes selecting (100) a precursor (104) to a thermally-labile group. Selecting (100) a precursor (104) to a thermally-labile group according to the method of FIG. 1 may be carried out in dependence upon a desired decomposition trigger temperature for the reworkable adhesive. That is, the precursor (104) to a thermally-labile group is typically selected in dependence upon a desired trigger temperature for decomposition of the resultant adhesive made by the method of FIG. 1. The desired trigger temperature is typically low enough to make reworking the adhesive practical and high enough such that the adhesive is itself stable and useful until it is reworked.

The method of FIG. 1 also includes selecting (102) the precursor (106) to a UV curable cross-linking monomer precursor. Selecting (102) the precursor (106) to a UV curable cross-linking monomer according to the method of FIG. 1 may be carried out in dependence upon a desired decomposition trigger temperature for the reworkable adhesive. That is, the precursor (106) to a UV curable cross-linking monomer is typically selected in dependence upon a desired trigger temperature for decomposition of the resultant adhesive made by the method of FIG. 1. The desired trigger temperature is typically low enough to make reworking the adhesive practical and high enough such that the adhesive is itself stable and useful until it is reworked.

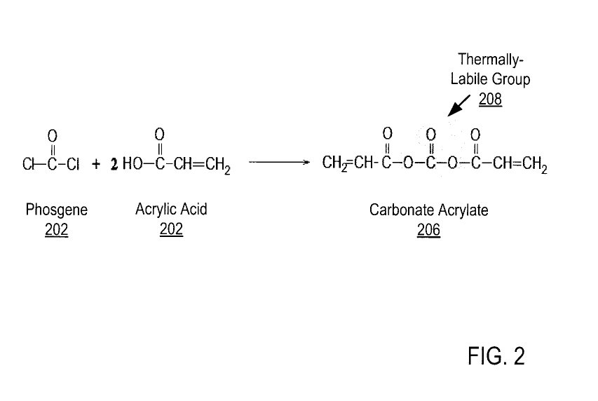

One precursor to a thermally-labile group useful in making reworkable adhesives according to the present invention is phosgene. A precursor to a UV curable cross-linking monomer useful in making reworkable adhesives using phosgene as the precursor to the thermally labile group is a hydroxyl-bearing UV curable cross-linking monomer, such as, for example, an α,β unsaturated carbonyl, such as acrylic acid as discussed below with reference to FIG. 2.

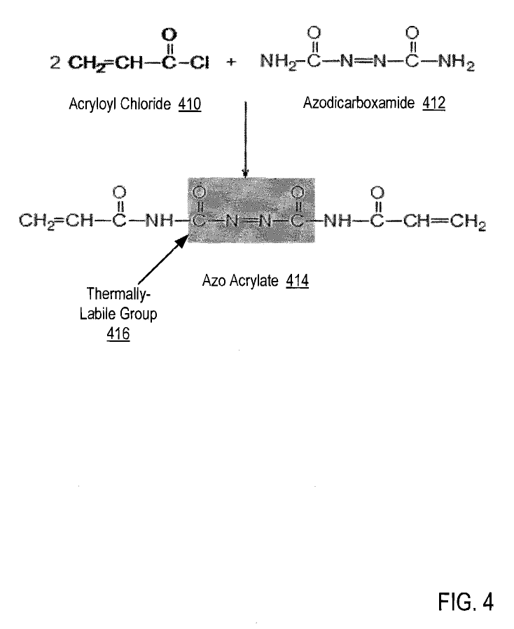

Another precursor to a thermally-labile group useful in making reworkable adhesives according to the present invention is azodicarboxamide. A precursor to a UV curable cross-linking monomer useful in making reworkable adhesives using azodicarboxamide as the precursor to the thermally labile group is acryloyl chloride as discussed below with reference to FIG. 4.

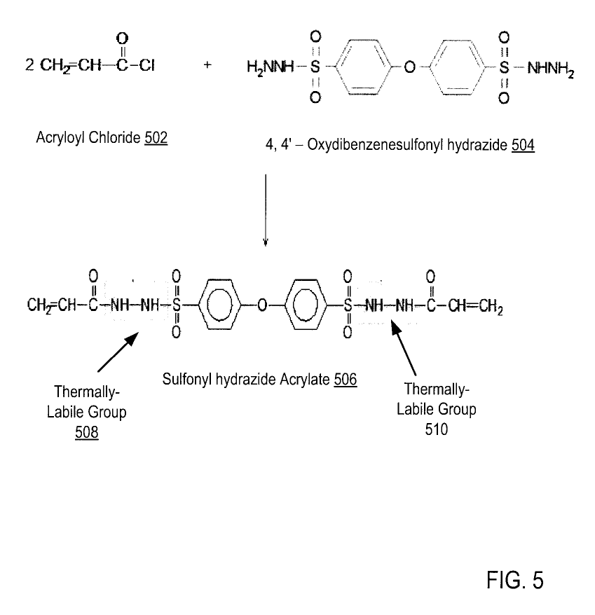

Still another precursor to a thermally-labile group useful in making reworkable adhesives according to the present invention is oxydibenzensulfonyl hydrazide. A precursor to a UV curable cross-linking monomer useful in making reworkable adhesives using oxydibenzensulfonyl hydrazide as the precursor to the thermally labile group is acryloyl chloride as discussed below with reference to FIG. 5.

The method of FIG. 1 also includes reacting (107) the selected precursor (104) to a thermally-labile group and the selected precursor (106) to a UV curable cross-linking monomer. The product of the reaction is a thermally-labile UV curable cross-linking monomer. Examples of such thermally-labile UV curable cross-linking monomers include carbonate acrylate discussed below with reference to FIG. 2, azo acrylate discussed below with reference to FIG. 4, sulfonyl hydrazide acrylate discussed below with reference to FIG. 5, and many others as will occur to those of skill in the art.

The method of FIG. 1 also includes combining (111) the product (109) of the reaction of the precursor (104) to a thermally-labile group and the precursor (106) to a UV curable cross-linking monomer with a photoinitiator (108) and a filler (110). A photoinitiator is an agent which forms a reactive element which starts a chain reaction to cause polymer formation when exposed to a specific wavelength of light. Photoinitiators useful in making reworkable adhesives according to the present invention often include photoinitiators suited for free radical polymerization, for example, benzoin and its derivatives, benzil ketals, acetophenone, acetophenone derivatives, anthraquinones, anthraquinone derivatives, benzophenone, benzophenone derivatives, triazine derivatives, and others as will occur to those of skill in the art.

The method of FIG. 1 also includes a filler (110). The filler (110) of FIG. 1 may be an electrically or thermally conductive or non-conductive filler depending upon the desired use of the resultant adhesive.

The method of FIG. 1 also includes UV curing (114) the combination (112) of the product of the reaction of the precursor to a thermally-labile group and the precursor to a UV curable cross-linking monomer, the photoinitiator and the filler. UV curing uses ultraviolet light or other radiation sources to initiate curing, which allows bonding without heating.

As discussed above, many combinations of precursors to thermally-labile groups and precursors to UV curable cross-linking monomers may be selected for making reworkable adhesives according to the present invention. For further explanation, therefore, FIG. 2 sets forth an exemplary reaction in accordance with the present invention. In the example of FIG. 2 the selected precursor (202) to a thermally-labile group is phosgene and the selected precursor to a UV curable cross-linking monomer is acrylic acid (204). In the exemplary reaction of FIG. 2, phosgene (202) is reacted with acrylic acid (204) to form carbonate acrylate (206) having a thermally-labile group (208). The carbonate functionality can be thermally degraded at an elevated trigger temperature releasing CO₂.

The resulting carbonate acrylate may be formulated into a UV curable composition by appropriate selection of photoinitiator, filler and so on as will occur to those skilled in the art. Following exposure to UV radiation, the carbonate acrylate crosslinks to form an intractable network. If this resultant material is subjected to elevated temperatures above a predetermined trigger temperature, the carbonate moiety thermally degrades fragmenting the network into much shorter, lower molecular weight sections thereby rendering the composition either volatile, soluble, or a combination of both and therefore reworkable.

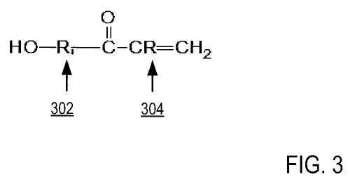

While the exemplary reaction of FIG. 2 sets forth acrylates, the adhesives according to the present invention are not limited to acrylates. For further explanation, therefore, FIG. 3 depicts a generalized formula of thermally-labile product useful in making reworkable adhesives according to embodiments of the present invention wherein the precursor to the UV curable cross-linking monomer is a hydroxyl-bearing monomer. In the generalized formula of FIG. 3, R may be selected from the group of H (acrylates), CH₃ (methacrylates), alkyl, arylalkyl, alkoxy, or other common substituents known to those skilled in the art; R1 may be selected from the group of alkyl, aryl, arylalkyl, or other common substituents known to those skilled in the art

As discussed above, many combinations of precursors to thermally-labile groups and precursors to UV curable cross-linking monomers may be selected for making reworkable adhesives according to the present invention. For further explanation, FIG. 4 sets forth another reaction useful in making reworkable adhesives in accordance with the present invention. In the example of FIG. 4, the precursor to a thermally-labile group is azodicarboxamide (412), and two moles of acryloyl chloride (410), which is a precursor to a UV curable cross-linking monomer, are reacted with the azodicarboxamide (412). Azodicarboxamide decomposes to nitrogen, ammonia, CO, and CO₂ at a trigger temperature of 190° C. The product of the exemplary reaction of FIG. 4 is a thermally-labile monomer Azo Acrylate (414) having a thermally labile group (416).

For still further explanation, FIG. 5 sets forth another reaction useful in making reworkable adhesives in accordance with the present invention. In the example of FIG. 5, the precursor to a thermally-labile group is oxydibenzenesulfonyl hydrazide (504) and two moles of acrylolyl chloride (502), which is a precursor to a UV curable cross-linking monomer, are reacted to form sulfonyl hydrazide acrylate (506). That is, oxydibenzenesulfonyl hydrazide (504) (the thermally-labile group precursor) is reacted with two moles of acrylolyl chloride (502) (a precursor to a UV curable cross-linking monomer) to form sulfonyl hydrazide acrylate (506). The sulfonyl hydrazide decomposes to nitrogen and water vapor at a trigger temperature of 153-167° C. The product of the reaction is sulfonyl hydrazide acrylate (506) having a thermally-labile groups (508 and 510).

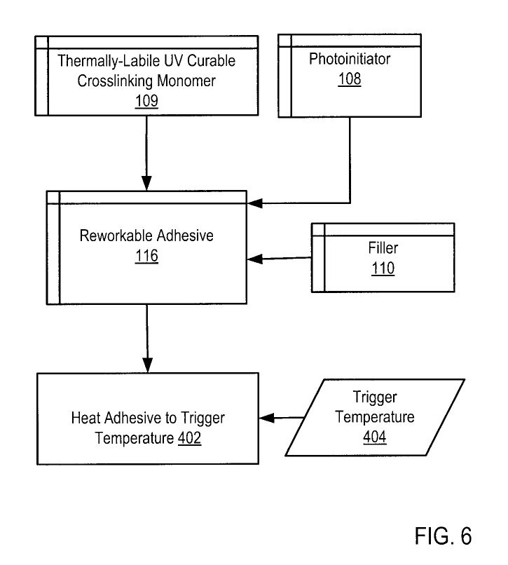

As discussed above, adhesives according to embodiments of the present invention are reworkable. For further explanation, FIG. 6 sets forth a flow chart illustrating an exemplary method for reworking an adhesive substance according to the present invention. In the example of FIG. 6 the substance comprises the cured product of a thermally labile monomer (109) synthesized from a reaction of a precursor to a thermally-labile group and a precursor to a UV curable cross-linking monomer; a photoinitiator (108); and a filler (110) as discussed above with reference to FIG. 1. The method of FIG. 6 includes heating (402) the reworkable adhesive substance (116) to a trigger temperature (404). Heating (402) the adhesive substance (116) to a trigger temperature (404) causes the thermally-labile group in the adhesive substance to degrade fragmenting the network into much shorter, lower molecular weight sections thereby rendering the adhesive either volatile, soluble, or a combination of both and therefore reworkable.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of making a reworkable adhesive, the method comprising:
reacting a precursor to a thermally-labile group and a precursor to a UV curable cross-linking monomer;
combining the product of the reaction of the precursor to a thermally-labile group and the precursor to a UV curable cross-linking monomer with a photoinitiator and a filler; and
UV curing the combination of the product of the reaction of the precursor to a thermally-labile group and the precursor to a UV curable cross-linking monomer, the photoinitiator and the filler.

2. The method of claim 1 wherein the precursor to a UV curable cross-linking monomer further comprises hydroxyl-bearing UV curable cross-linking monomer.

3. The method of claim 2 wherein the hydroxyl-bearing UV curable cross-linking monomer further comprises an α, β unsaturated carbonyl.

4. The method of claim 3 wherein the α, β unsaturated carbonyl further comprises acrylic acid.

5. The method of claim 1 wherein the precursor to the thermally-labile group further comprises phosgene.

6. The method of claim 1 wherein the precursor to a thermally-labile group further comprises azodicarboxamide.

7. The method of claim 1 wherein the precursor to a UV curable cross-linking monomer further comprises acryloyl chloride.

8. The method of claim 1 wherein the precursor to a thermally-labile group further comprises oxydibenzensulfonyl hydrazide.

9. The method of claim 1 wherein the a precursor to a UV curable cross-linking monomer further comprises acryloyl chloride.

10. The method of claim 1 further comprising selecting the precursor to a thermally-labile group in dependence upon a desired decomposition trigger temperature for the reworkable adhesive.

11. The method of claim 1 further comprising selecting the precursor to a UV curable cross-linking monomer precursor dependence upon a desired decomposition trigger temperature for the reworkable adhesive.

12. A reworkable adhesive substance, the adhesive substance comprising the cured product of:
a thermally labile monomer synthesized from a reaction of a precursor to a thermally-labile group and a precursor to a UV curable cross-linking monomer;
a photoinitiator; and
a filler.

13. The substance of claim 12 wherein the precursor to a UV curable cross-linking monomer further comprises hydroxyl-bearing UV curable cross-linking monomer.

14. The substance of claim 13 wherein the α, β unsaturated carbonyl further comprises acrylic acid and the precursor to the thermally-labile group further comprises phosgene.

15. The substance of claim 12 wherein the precursor to a thermally-labile group further comprises azodicarboxamide and the precursor to a UV curable cross-linking monomer further comprises acryloyl chloride.

16. The method of claim 12 wherein the precursor to a thermally-labile group further comprises oxydibenzenesulfonyl hydrazide and the precursor to a UV curable cross-linking monomer further comprises acryloyl chloride.

17. A reworkable adhesive made by the process comprising:
reacting a precursor to a thermally-labile group and a precursor to a UV curable cross-linking monomer; and
combining a product of the reaction of the precursor to a thermally-labile group and the precursor to a UV curable cross-linking monomer with a photoinitiator, and a filler; and
UV curing the combination of the product of the reaction of the precursor to a thermally-labile group and the precursor to a UV curable cross-linking monomer, the photoinitiator and the filler.
